(19) United States
(12) Patent Application Publication
(10) Pub. No.: US 2014/0199019 A1
(43) Pub. Date: Jul. 17, 2014

(54) Optical Engine

(71) Applicant: Gnitabouré YABRE, Mainvilliers (FR)

(72) Inventor: Gnitabouré YABRE, Mainvilliers (FR)

(73) Assignee: FCI, Guyancourt (FR)

(21) Appl. No.: 13/989,575

(22) PCT Filed: Nov. 25, 2011
(86) PCT No.: PCT/IB2011/003198

§ 371 Date: Feb. 18, 2014

(30) Foreign Application Priority Data
Nov. 25, 2010 (RO) PCTIB2010 003427

(51) Int. Cl. G02B 6/42

(52) U.S. Cl. CPC G02B 6/4204
USPC 385/14

(57) ABSTRACT

The invention is related to an optical engine comprising: including at least one optoelectronic component for emitting or receiving light; a substrate for carrying the optoelectronic component; an optical coupling device, configured for guiding light between the optoelectronic component and an optical waveguide, fixed to the substrate. At least the substrate and the coupling device comprise include a fixation element and the other one a complementary fixation element, the complementary fixation element cooperating with the fixation element to locate and fix the coupling device to substrate so as to achieve an optical coupling between the optoelectronic component and the optical coupling device.

### FIELD OF THE INVENTION

The instant invention relates to an optical engine.

### BACKGROUND OF THE INVENTION

Because of the ever increasing requirements in data rates in communication systems, due for example to the Internet, the limits of using electrical communications between printed circuit boards (PCB) are being reached. It has become difficult to guarantee good signal integrity when transferring information at high frequencies (e.g. 25 Gb/s or higher) through electrical lines between two electrical components such as a printed circuit board.

To respond to this bandwidth demand, high-speed systems now use optical waveguide light to transfer light-carried information.

Light enables to improve the transfer of information between two points since light is less sensitive to interference phenomenon. However, electronic infrastructures (such as telecom cabinet) still implement printed circuit boards which still use electricity-carried information. So, it is necessary to implement on the printed circuit board devices designed for converting light to/from electricity and for directing light into/from the optical waveguide.

To this end, it has been proposed on the market devices, such as optical transceiver and active optical cable which are capable to convert optical signal into electrical signal and vice versa. These devices comprise an active component called as optical engine, whose function is to manage electrical/optical signal conversion.

An optical engine may comprise a substrate which supports optoelectronic components and an optical coupling device configured for guiding light from/towards the optoelectronic components to/from an optical waveguide.

In order to improve information transfer in these optical engines, there is a need to improve the optical coupling between the optoelectronic components and the optical waveguide.

An object of the present invention is to provide an optical engine with improved optical coupling, and which is easier and less expensive to manufacture.

### SUMMARY OF THE INVENTION

To this aim, the optical engine according to the invention is adapted to guide light between an optical waveguide and at least one optoelectronic component carried by a substrate. The substrate is fixed to the optical coupling device. The optical coupling device comprises at least one fixation element configured for cooperating with a complementary fixation element of the substrate to position and fix of the coupling device to the substrate so as to achieve an optical coupling between the optoelectronic component and the optical coupling device.

With this feature, the coupling device and the substrate are precisely and passively positioned one with respect to the other. Thus the optical coupling between the coupling device and the optoelectronic component is obtained by a simple fashion i.e. by means of mechanical cooperating elements. There is therefore no need to make use of fiducial marks, both formed on the substrate and the coupling device, which requires the implementation of positioning camera to locate the respective fiducial marks, so as to match the marks between the coupling device and the substrate to guarantee the optimal optical coupling.

Advantageously, the coupling device is quickly, simply and precisely mounted on the substrate during the manufacturing in series of the optical engine, for example by press fitting or plug-in. Indeed, it is easier to build up for example by moulding or cutting a fixation element and a complementary fixation element with precision than gluing with an exact positioning the optical device to the substrate, which are both tiny components.

Advantageously, the optical coupling device is accurately aligned with respect to the substrate and consequently with respect to the optoelectronic component so that thin light beams, emitted towards the waveguide or received from it, impinge exactly on the optoelectronic components.

In some embodiments, one might also uses one or more of the features defined in the dependant claims.

### BRIEF DESCRIPTION OF THE DRAWINGS

Other characteristics and advantages of the invention will readily appear from the following description of eight of its embodiments, provided as non-limitative examples, and of the accompanied drawings.

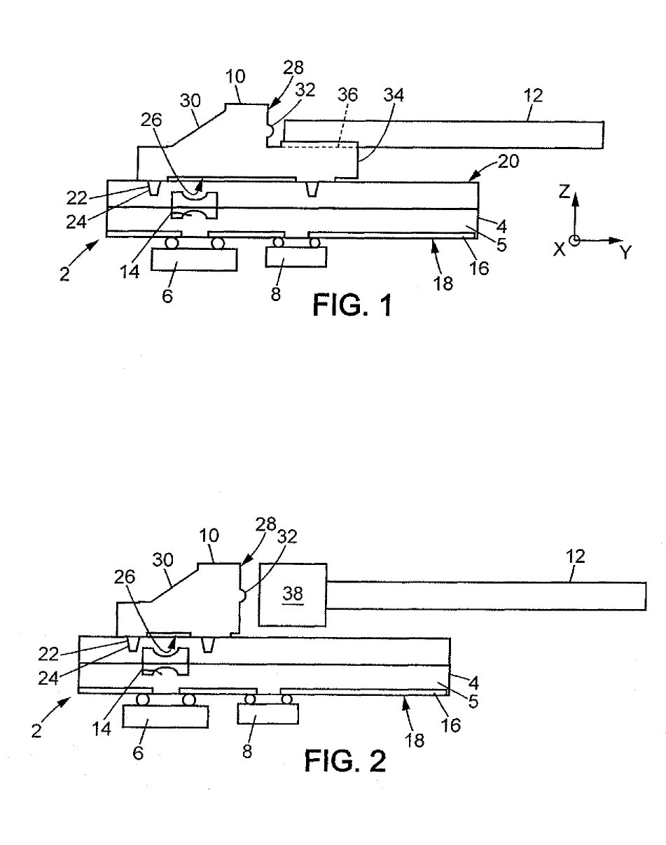

On the drawings FIGS. 1 to 8 are schematic side views of the optical engine according to eight embodiments of the instant invention.

On the different figures, the same references signs designate like or similar elements.

### DETAILED DESCRIPTION

Referring to FIG. 1, the optical engine 2 according to a first embodiment of the invention comprises a substrate 4 configured for carrying rows of optoelectronic components 6 and an optical coupling device 10. The optical coupling device 10 is adapted for guiding light between the optoelectronic components 6 and an optical waveguide 12.

According to the first embodiment, the substrate 4 is an optical subassembly 5 made of two layers of transparent material such as plastic, moulded glass or fused silica. The optical subassembly 5 can, for example, be mounted on a mother board carrying electronic components which are electrically linked to the optoelectronic components 6.

The optical subassembly 5 comprises at least one lens 14 or other suitable light-beam forming device in front of each optoelectronic component 6 to enhance the optical coupling between the optical coupling device 10 and the optoelectronic component 6. The lenses 14 are for example laser cut within the material of the optical subassembly 5.

On the schematic representation of FIG. 1, the optoelectronic components 6 are arranged in one row which extends along the X axis. Commonly, the optoelectronic components 6 are arranged in rows and columns.

The optoelectronic components 6 are e.g. light-emitting optoelectronic devices such as vertical-cavity surface emitting lasers (VCSEL) and light-receiving optoelectronic devices such as photo-diodes or photo-detectors. Lenses (not represented) may also be disposed at the output of the lasers.

The optoelectronic components 6 are electrically connected to the optical subassembly 5 by flip-chip bonding. Electrical tracks 16 are provided on a first principal face 18 of the optical subassembly 5. This first principal face 18 is hereafter named bottom face 18. The optical device 10 is fixed on a second principal face 20 of the optical subassembly 5 which is opposite to the bottom face 18. This second principal face 20 is named hereafter top face 20. Light beams coming from or going to the optoelectronic components 6 cross the optical subassembly 5 widthways before penetrating into the optical coupling device 10 or after exiting the optical coupling device 10 respectively.

The optoelectronic components 6 may be electrically connected to an electronic control device 8 configured for driving them.

The optical coupling device 10 is, for example, a unitary integrally moulded transparent plastic part or glass material.

The optical coupling device 10 comprises a first interface 26 configured for receiving light output from or emitting light towards the optical subassembly 5, and a second interface 28 configured for emitting light towards or receiving light from the optical waveguide 12, such as an optical fiber.

Each optical interface 26 and 28 comprises optical transmission regions arranged in one row according to the embodiment shown on FIG. 1. Each transmission region is associated to a corresponding optoelectronic component 6 and an optical fibre of the waveguide 12.

The optical coupling device 10 further comprises a reflective arrangement 30 adapted to guide light from/directed to each transmission region of the first interface to/from respective each respective transmission region of the second optical interface 28.

For example, the reflective arrangement 30 comprises one or several mirrors oriented at 45° with respect to the X-Y plane, and extending along the X axis.

The second interface 28 can comprise lenses 32, placed at the extremity of each transmission region, either to focus the light beams into the optical fibre cores of the waveguide 12 or to collimate light beams coming out the optical fibre core.

The optical coupling device 10 comprises for example four fixation elements 22 which are configured to mate with four complementary fixation elements 24 of the optical subassembly 5. The fixation element 22 and the complementary fixation element are used to position and fix the coupling device 10 to the optical subassembly 5 at a precise location one with respect to the other and with respect to the optoelectronic components 6 both in the X-Y plane as well as along the Z axis.

An exact alignment of the transmission regions of the first optical interface 26 with the optoelectronic components 6 is required because the reception surface of the transmission region and the reception area or emitting area of the optoelectronic components are very small, for example, in the range of about ten micrometers.

In the example of the invention shown on FIG. 1, the fixation elements 22 are constituted by feet or male elements adapted to fit with corresponding holes or female elements 24 disposed on the top face 20 of the optical subassembly.

Advantageously, the coupling between male elements and female elements affords a quick and simple assembling of the optical coupling device 10 to the optical subassembly, for example by press-fitting or plug-in.

Advantageously, the fixation elements 22 are furthermore stuck in the complementary fixation elements 24.

In variant, the optical subassembly comprises male elements adapted to be plug into female elements of the optical coupling device.

According to the embodiment shown on FIG. 1, the optical device 10 comprises an extension 34 forming a support element of a V-shaped groove 36. This V-shaped groove is configured for supporting and fixing the optical waveguide 12. As shown on FIG. 1, the median line of the V-shaped groove 36 extends along the Y axis.

This V-groove allows a precise alignment between the transmission regions of the second interface 28 and the openings of the optical fibres.

In variant, the groove is U-shaped and is equipped with elastic blades for retaining the optical waveguide.

With this feature, the waveguide 12 is advantageously quickly and exactly fixed to the optical device 10 during the manufacturing process.

FIG. 2 now schematically shows a second embodiment of the invention. Compared with the first embodiment, the second embodiment differs in that the optical device 10 does not comprise an extension 34 or any element for supporting the optical waveguide 12. In this embodiment, the end of the waveguide 12 comprises a mechanical transfer ferrule 38 which receives optical fibres in precisely defined locations for exact positioning with the transmission regions of the optical device second interface 28.

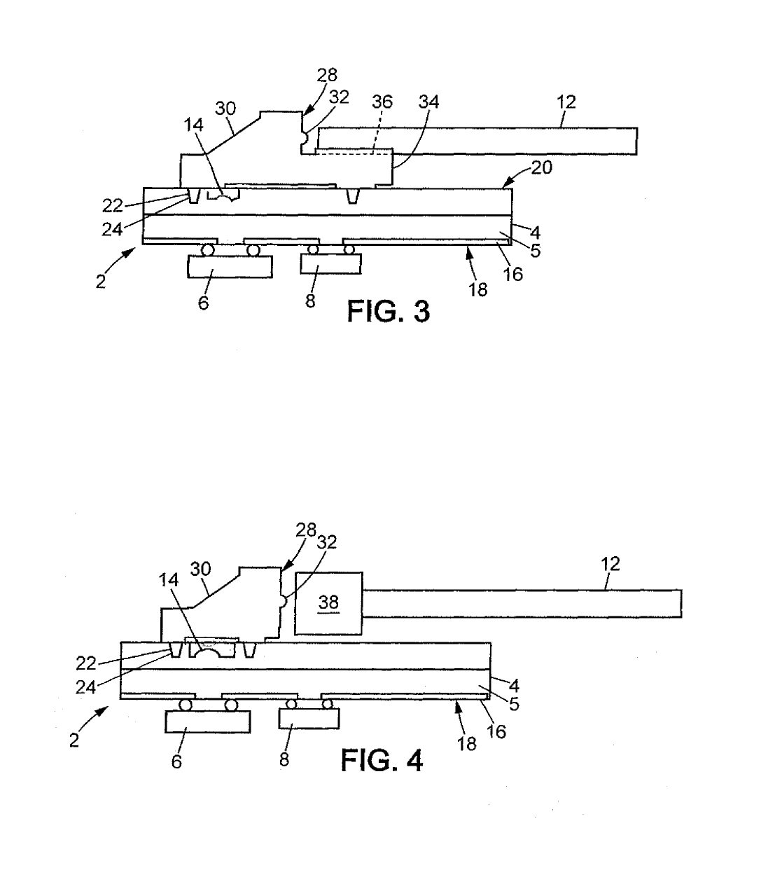

FIG. 3 now schematically shows a third embodiment of the invention. Compared to the first embodiment, it mainly differs in that the lenses 14 are not built up within the optical subassembly 5. Instead, the lenses 14 are fixed or formed on the top principal face 20 of the optical subassembly 5. Lenses 14 are configured for collimating the light beams emitted by the optoelectronic component 6.

FIG. 4 schematically shows a fourth embodiment of the invention. Compared to the second embodiment, it mainly differs in that the lenses 14 are not built up within the optical subassembly 5. Instead, the lenses 14 are fixed or formed on the top principal face 20 of the optical subassembly 5. Lenses 14 are configured for collimating the light beams emitted by the optoelectronic component 6.

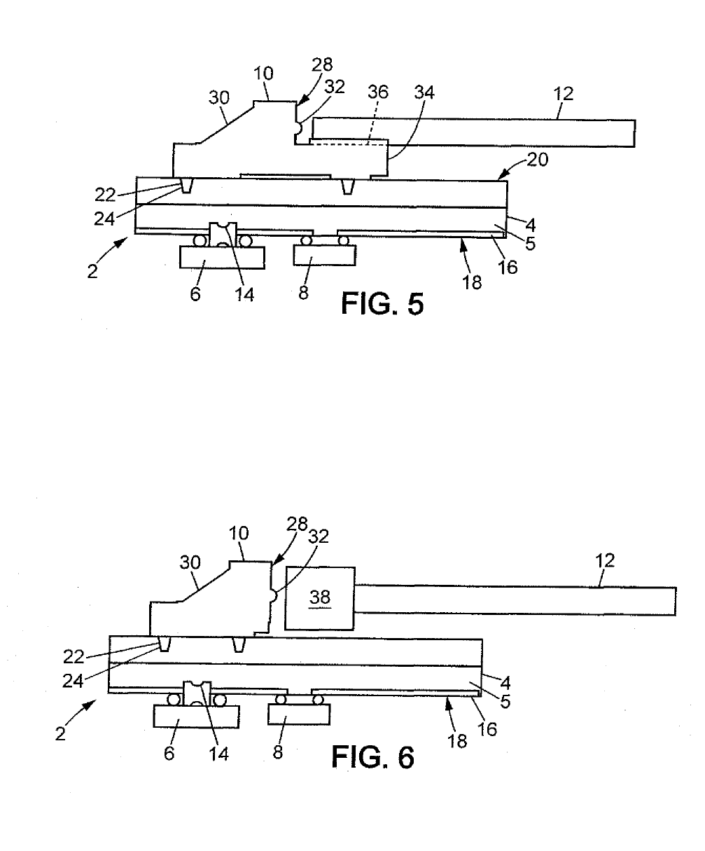

FIG. 5 now schematically shows a fifth embodiment of the invention. Compared to the first embodiment, it mainly differs in that the lenses 14 are not built up within the optical subassembly 5. Instead, lenses 14 are fixed or formed on the principal bottom face 18 of the optical subassembly 5. In this case, the lenses 14 can be configured for collimating or focussing the light beams.

FIG. 6 schematically shows a sixth embodiment of the invention. Compared to the second embodiment, it mainly differs in that the lenses 14 are not built up within the optical subassembly 5. Instead, the lenses 14 are mounted on the principal bottom face 18 of the optical subassembly 5. Lenses 14 can be configured for collimating or focussing the light beams. In the latter case, other lenses are provided on the first optical interface 26 of the coupling device 10 for collimating the light beams.

According to variants of the embodiments of FIGS. 1 to 6, it is possible to provide the back wall of the coupling device, i.e. the first optical interface, with a lens. Thanks to this arrangement, there is no need to have lens formed with the optical subassembly 5.

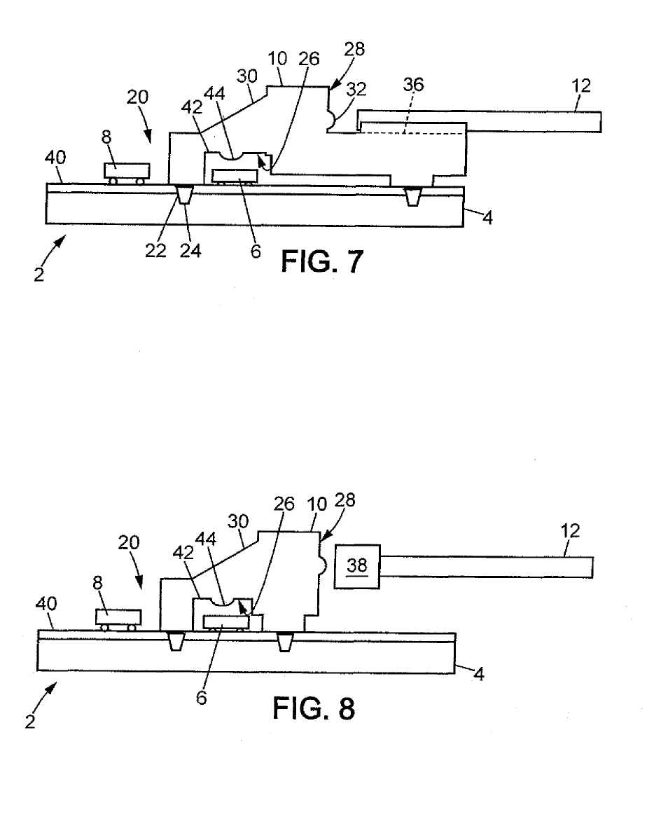

FIG. 7 schematically shows a seventh embodiment of the invention. Compared to the first embodiment, it mainly differs in that the substrate 4 is not an optical subassembly made of transparent material and the optoelectronic components 6 are not mounted on the bottom face 18 of the substrate. Instead, the substrate 4 is made of a non transparent material, for example ceramic or epoxy resin prepreg. The optoelectronic components 6 are mechanically and electrically connected to an electrically conductive track 40 deposited on the principal top face 20 of the substrate. In this case, the optical device 10 comprises a cavity 42 adapted to lodge the optoelectronic components 6.

Advantageously, in this embodiment, each transmission region of the second optical interface 26 which forms the back wall of the cavity 42 is provided with a lens 44.

FIG. 8 schematically shows the eighth embodiment of the invention. Compared to the seventh embodiment, it mainly differs in that the optical device 10 does not comprise an extension 34. Instead, the extremity of the waveguide 12 comprises a mechanical transfer ferrule 38.

The optical engine according to the present invention finds application in the field of optical transceivers and in that one of active optical cables (AOCs). In the latter case, the optical engine is mounted onto a paddle board (or printed circuit board) of the AOC device.

1. Optical engine comprising:
at least one optoelectronic component for emitting or receiving light;
a substrate for carrying the optoelectronic component;
an optical coupling device, configured for guiding light between the optoelectronic component and an optical waveguide, fixed to the substrate
wherein at least the substrate and the coupling device comprise a fixation element and the other one a complementary fixation element, the complementary fixation element cooperating with the fixation element to locate and fix the coupling device to substrate so as to achieve an optical coupling between the optoelectronic component and the optical coupling device.

2. Optical engine according to claim 1, wherein the fixation element is a male element and the complementary fixation element is a female element.

3. Optical engine according to claim 1, wherein the substrate is an optical subassembly adapted to transmit light, the coupling device being fixed to one principal face of the optical subassembly and the optoelectronic component being fixed to the opposite principal face of the optical subassembly.

4. Optical engine according to claim 1, wherein the optical coupling device comprises at least one lens fixed on a first optical interface of the optical coupling device; the lens facing the optoelectronic component.

5. Optical engine according to claim 3, wherein the optical subassembly comprises at least one lens.

6. Optical engine according to claim 5, wherein the lens is built up on one principal bottom face of the optical subassembly.

7. Optical engine according to claim 5, wherein the lens is built up on one principal top face of the optical subassembly.

8. Optical engine according to claim 1, wherein the substrate is made of non transparent material, the optoelectronic component being fixed on a principal face of the substrate; the coupling device being also fixed to this principal face.

9. Optical engine according to claim 1, wherein the optical coupling device further comprises a fastening component adapted to position and attach the optical waveguide to the optical device.

10. Optical engine according to claim 9, wherein the fastening component comprises a groove.

11. Optical engine according to claim 9, wherein the fastening component comprises a mechanical transfer ferrule.
